(19) United States
(12) Patent Application Publication
(10) Pub. No.: US 2003/0204424 A1
(43) Pub. Date: Oct. 30, 2003

(54) Management by objectives

(76) Inventors: Walter Koller, Bad Schonborn (DE); Mathias Schoenecker, Forst (DE); Maurice Hagen, Heidelberg (DE)

Correspondence Address: MARK D. KIRKLAND, Fish & Richardson P.C. P.A., 3300 Dain Rauscher Plaza, 60 South Sixth Street, Minneapolis, MN, 55402, US

(21) Appl. No.: 10/135,890

(22) Filed: Apr. 29, 2002

(51) Int. Cl. G06F 17/60

(52) U.S. Cl. 705/7

(57) ABSTRACT

A software program assists in establishing goals and objectives and tracking the completion of the objectives. The goals for an organization are determined, and individual objectives based on the goals are defined. The software program links the individual objectives to incentives, and these individual objectives may be modified by the program during a defined cycle. A final appraisal is conducted at the end of the cycle, and the program determines which individual goals were achieved. Future objectives may be determined during the final appraisal. The program may award the incentives based on the individual goals achieved.

### TECHNICAL FIELD

This invention relates to personnel management software, and more particularly to objective and goal setting management systems.

### BACKGROUND

Global competition not only forces enterprises to optimize their operating business processes, it also means that they have to react to new developments on a strategic level. Although most enterprises are far from being strategically optimized, this is exactly what will separate successful enterprises from less successful ones in the future.

This dynamic change in the enterprise environment means that human resource (HR) departments, too, face completely new tasks. It is no longer enough to support enterprise strategy with cost-optimized personnel management and to provide qualified employees. The future of personnel management lies in a consistent, strategic orientation. HR departments must ask themselves what part they can play in reaching enterprise goals and how they can increase the value of the enterprise.

By proactively participating in the implementation of enterprise strategy, an HR department can develop into an important link in the value chain and position itself as consultant and partner for management and employees.

Several factors are very important here: reliable cost planning, new recruitment processes, building up compensation models that are internationally recognized and comparable, and the introduction of up-to-the-minute systems for personnel management, communication, and analysis. But until now, there have been no integrated, e-business software solutions that handle these processes and also offer complex evaluation, analysis, and simulation options.

### SUMMARY

A software program assists in establishing goals and objectives and tracking the completion of the objectives. The goals for an organization are determined, and individual objectives based on the goals are defined. The software program links the individual objectives to incentives, and these individual objectives may be modified by the program during a defined cycle. A final appraisal is conducted at the end of the cycle, and the program determines which individual goals were achieved. Future objectives may be determined during the final appraisal. The program may award the incentives based on the individual goals achieved.

### DESCRIPTION OF DRAWINGS

These and other features and advantages of the invention will become more apparent upon reading the following detailed description and upon reference to the accompanying drawings.

FIG. 1 illustrates the goal setting process of an organization using both a top-down and a bottom-up process.

FIG. 2 illustrates a complete cycle of the management by objective process including planning, review, and appraisal.

FIG. 3 illustrates a process for implementing the management by objective system.

### DETAILED DESCRIPTION

Converting company goals into concrete, measurable employee objectives creates clearly defined expectations. The employees are then better able to meet their individual goals, and the performance of the employees is more easily measured. Management by Objectives creates and utilizes a concrete set of company goals. A Balanced Scorecard is often used in conjunction with Management by Objectives. Scorecards allow development of employee objectives that are based on your enterprise's goals and visions. The definition of a balanced scorecard is based on four perspectives that contribute to the success of an enterprise:

Financial

Customer

Process

Learning and development

At the enterprise level, strategic enterprise goals are set to be met for each of these perspectives. You can then break down these goals to area and department goals and store them in scorecards. For each strategic goal in a scorecard, concrete initiatives and key figures are defined. In other words, the objective, how it will be reached, and what measurement will be used to determine if it was reached is described. As a final step, departmental goals are broken down into objectives for individual employees.

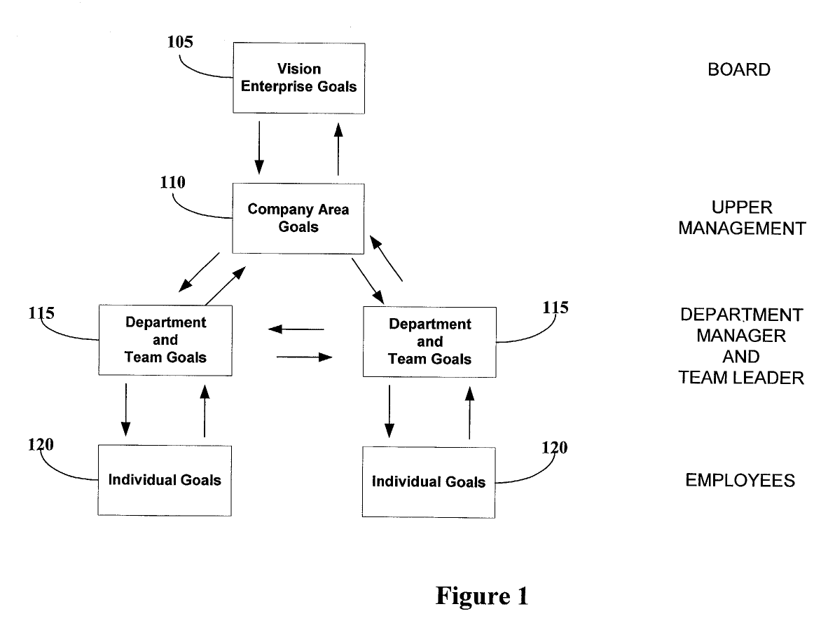

Referring to FIG. 1, objectives are set during planning meetings that take place at every level of the enterprise. The objectives may begin at the board level, where vision enterprise goals 105 are determined. An upper management level may take the vision enterprise goals 105 and determine the company area goals 110 that are needed for each area of the company to achieve the vision enterprise goals 105. The company area goals 110 are forwarded to the department manager and team leader level, where department and team goals 115 are determined. From the department and team goals 115, individual goals 120 may be created at the employee level.

The vision enterprise goals 105 that the executive team has are communicated from the top down—from executives to managers to employees. During this process, the goals are differentiated and adjusted appropriately. Planning meetings provide a forum for soliciting employees' ideas and opinions and gaining employees' commitment to achieving objectives. As FIG. 1 illustrates, this transforms a top-down approach into a bottom-up process that includes all employees—one that can greatly increase employees' commitment to achieving objectives. The goals may be recorded in a software program such as SAP Strategic Enterprise Management (SEM).

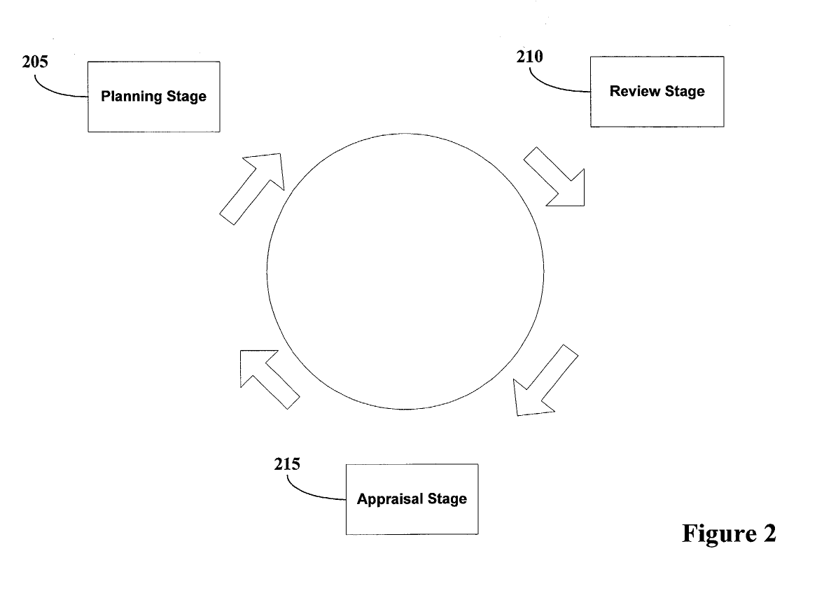

As shown in FIG. 2, the management by objective process starts with a planning stage 205 including objective-setting interviews between employees and their superiors. During the interview, the superior and employee agree on concrete objectives (quantitative and qualitative) that are to be reached by an agreed-upon date.

Ideally, these concrete objectives support the vision enterprise goals 105 (which need to be communicated to employees in advance). In this way, employees can understand how they contribute to the success of the enterprise. If this method of personnel management is to be successful, both short-term objectives (those related to immediate performance) and long-term objectives (those related to personnel development and the mastery of competencies) should be defined, and employees should agree to complete them. Objectives should be realistic and achievable without being trivial. Linking the attainment of objectives to an employee's salary can increase the success of this method. The agreed upon objectives are recorded in the system and can be added to personnel files.

A review stage 210 provides feedback for the employee in the management by objectives process. The date for a review is set during the objective-setting interview. A formalized review takes place during the year and helps to ensure that employees do not lose sight of the objectives. At this review, the participants can compare the objectives with the results they have already achieved, determine if the objectives are still relevant, and modify them as necessary. If an additional review is required, the participants can set a new date.

In the appraisal stage 215, a final evaluation is conducted, based on the degree to which the employee has achieved objectives. If required, the immediate superior, several superiors, colleagues, employees, and even the individual being evaluated can perform the appraisal. Depending on the final appraisal, an employee's salary may be adjusted accordingly. At the same time, the planning stage 205 for the following period can be conducted, thus completing the cycle.

When a superior and employee have agreed upon the objectives, they can complete an objective-setting agreement (also known as an appraisal document) that records the objectives. The objective-setting agreement serves as the basis for reviews and for the final appraisal. The objective-setting agreement may be created using a template that may be accessed from a web interface or any other user interface. Because objectives are only usually set once a year, simple and intuitive Web interfaces have the advantage that they require little or no training, and acceptance is usually very high.

The department and team goal 115 and individual goals 120 may be automatically pulled from the departmental scorecard in a software program such as SAP SEM. These goals then appear as text in the objective-setting agreement. In addition, there can be a link to your department's Balanced Scorecard in SAP SEM so that employees can view departmental goals and their dependencies at any time.

The objective-setting agreement may define certain objectives, such as skills or knowledge that all employees in a department need to meet future challenges. For example, these objectives can be qualifications that are taken from a qualifications catalog. When the appraisal is complete, an employees' qualifications and proficiencies may be automatically inserted into their qualifications profiles.

Objectives may also be obtained from a requirements profile of the employee's position. Using Business Add-Ins (BAdI) technology, objectives may be further created automatically. For example, the requirements profile of a related job may be used to create objectives. Individual objectives may also be created so HR professionals and managers can take into account employees' special development objectives and their particular tasks.

The flexibility to create objectives means that those with personnel responsibility have numerous ways of differentiating between employees. This ensures that the performance requirements and the developmental potential of employees are taken into account properly, and it paves the way for employees to achieve their objectives effectively.

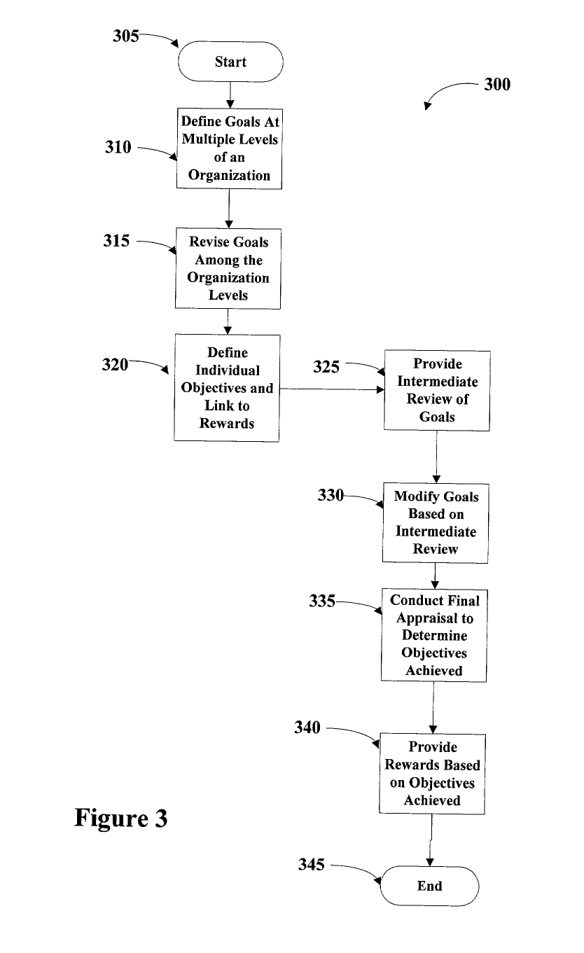

A process 300 for managing by objectives is illustrated in FIG. 3. The process 300 begins at a START block 305. Proceeding to block 310, the process 300 defines the objectives or goals at multiple levels of an organization. As shown in FIG. 1, these goals may begin with the Board, and be defined at multiple levels including upper management, department manager, team leader, and individual employee. of course, goals may be set at many different levels of an organization. The number of levels to set goals may vary among organizations depending on the organizations size and structure.

Proceeding to block 315, the process 300 then revives the goals among each of the different levels. The goals are adjusted based on the goals from the other levels. The goals may be communicated among levels and adjusted during planning meetings, where the goals are discussed and adjusted. This allows the setting and communicating of the goals to flow in both directions of the company, as illustrated in FIG. 1.

Proceeding to block 320, the process 300 defines objectives for individual employees or departments based on the goals established above. By creating individual objectives, the employees and departments have concrete, establish items to complete. The objectives may also be linked to rewards or incentives for achieving the objectives. For example, an employee's salary adjustment or bonus may be tied to achievement of an individual goal 120, or a department may be honored for achieving a department or team goal 115. By linking the goals to a set reward or incentives, people and departments may be more motivated to achieve the goals due to a concrete incentive. Also, linking objectives to individual employees or departments allows for a more definite determination of job success.

Proceeding to block 325, the process 300 may provide a mechanism for an intermediate review of goal accomplishment. The intermediate review may be conducted at set intervals throughout the entire process 300. For example, intermediate reviews may be conducted at three month or six month intervals.

Proceeding to block 330, the goals may be modified based on the results of the intermediate reviews. The reviews may determine that the goal is no longer important, or that the goal is too difficult to complete. By using intermediate reviews, the progress towards completing the goals can be monitored and the goals revised as the company strategy or personnel issue warrant.

Proceeding to block 335, a final appraisal is conducted to determine the goals achieved. The final appraisal may include a determination of the goals achieved during the cycle, and goals for the next cycle may be determined. The appraisal may consist of input from many different people, including the immediate supervisor, superiors, colleagues and other employees.

Proceeding to block 340, the process 300 provides rewards and incentives for achieving the goals based on the results of the final appraisal. The rewards and incentives may vary depending on the goals, by can include salary adjustment, bonuses, additional vacation time, or promotion. The rewards and incentives may also be determined for the next cycle. The process 300 then ends for the cycle in END block 345.

Numerous variations and modifications of the invention will become readily apparent to those skilled in the art. Accordingly, the invention may be embodied in other specific forms without departing from its spirit or essential characteristics.

What is claimed is:

1. A method of managing by objectives comprising:
determining goals for an organization;
defining individual objectives based on the goals;
linking the individual objectives to incentives;
modifying the individual objectives during a cycle; and
determining individual goals achieved at the end of the cycle.

2. The method of claim 1, further comprising revising the goals among multiple levels of the organization.

3. The method of claim 1, further comprising providing a review of progress toward meeting the individual goals during the cycle.

4. The method of claim 1, further comprising conducting a final appraisal at the end of the cycle.

5. The method of claim 4, further comprising setting future objectives during the final appraisal.

6. The method of claim 1, further comprising awarding the incentives based on the individual goals achieved.

7. An article comprising:
a storage medium having stored thereon instructions that when executed by a machine results in the following:
receive individual objectives based on the goals of an organization;
link the individual objectives to incentives;
modify the individual objectives during a cycle; and
determine individual goals achieved at the end of the cycle.

8. The article of claim 7, wherein the goals are revised among multiple levels of the organization.

9. The article of claim 7, wherein a review of progress toward meeting the individual goals is conducted during the cycle.

10. The article of claim 7, wherein a final appraisal is performed at the end of the cycle.

11. The article of claim 10, wherein future objectives are established during the final appraisal.

12. The article of claim 7, wherein the incentives are awarded based on the individual goals achieved.
